(19) United States
(12) Patent Application Publication
(10) Pub. No.: US 2024/0070779 A1
(43) Pub. Date: Feb. 29, 2024

(54) DATA MAPPING METHOD AND SYSTEM

(71) Applicant: Royal Bank of Canada, Toronto (CA)

(72) Inventors: Faina Koshetova, Richmond Hill (CA); Claire Lee, Toronto (CA); Ethan Lim, Edmonton (CA); Vivek Wadhwani, Toronto (CA)

(21) Appl. No.: 18/454,571

(22) Filed: Aug. 23, 2023

Related U.S. Application Data
(60) Provisional application No. 63/400,683, filed on Aug. 24, 2022.

(51) Int. Cl. G06Q 40/04; G06Q 20/38; G06Q 40/06

(52) U.S. Cl. CPC G06Q 40/04; G06Q 20/389; G06Q 40/06

(57) ABSTRACT

Methods, systems, and techniques for data mapping. Company identifiers and an electronic commerce transaction history, such as an online banking transaction history, of a user are retrieved from one or more data repositories. The electronic commerce transaction history includes purchases made from one or more companies identified by the company identifiers. Data mapping is then performed to associate the company identifiers with the purchases represented in the electronic commerce transaction history to identify the companies represented by the company identifiers from which the user made purchases. The company identifiers are then caused to be displayed on a graphical user interface as suggestions to the user as investment suggestions.

### CROSS-REFERENCE TO RELATED APPLICATION

The present application claims priority to U.S. provisional patent application No. 63/400,683, filed on Aug. 24, 2022, and entitled “Data Mapping Method and System”, the entirety of which is hereby incorporated by reference herein.

### TECHNICAL HELD

The present disclosure is directed at data mapping method and system.

### BACKGROUND

People are bombarded with information today. “Information overload” refers to how a person's decision making can be prejudiced as a result of being exposed to too much information. In particular, that person may be unable to identify relevant information from all the information they are exposed to, and even if they are able to identify relevant information may be too mentally taxed to suitably use it to make a decision. Accordingly, it would be beneficial to assist people with identifying relevant information and then present that information to them in a manner that facilitates decision making.

### SUMMARY

According to a first aspect, there is provided a method comprising: retrieving from one or more data repositories: company identifiers; and an online banking transaction history of a user, wherein the online banking transaction history comprises purchases made from one or more companies identified by the company identifiers; performing data mapping to associate the company identifiers with the purchases represented in the online banking transaction history to identify the companies represented by the company identifiers from which the user made purchases; and causing the company identifiers to be displayed on a graphical user interface.

The company identifiers may comprise stock tickers and associated stock exchanges.

The online banking transaction history may comprise a purchase transaction history of the user.

The data mapping may be performed using fuzzy string matching.

The method may further comprise: prompting the user to allocate a percentage of funds for use in purchasing an interest in the companies identified on the graphical user interface; and in accordance with an allocation specified by the user, automatically periodically transferring funds from one financial institution account of the user to another financial institution account of the user assigned for use to purchase the interest in the companies.

The method may further comprise, in response to the user selecting one of the company identifiers displayed on the graphical user interface, facilitating a purchase of the interest in the company identified by the one of the company identifiers.

The data mapping may be performed on one or more servers and causing the company identifiers to be displayed on the graphical user interface may comprise sending the company identifiers from the one or more servers to a user device for display on the user device.

The data mapping may be performed on a user device and causing the company identifiers to be displayed on the graphical user interface may comprise displaying the company identifiers on the user device.

According to another aspect, there is provided a system comprising: a transaction database; an asset database; one or more servers configured to: retrieve from the asset database company identifiers; and retrieve from the transaction database an online banking transaction history of a user, wherein the online banking transaction history comprises purchases made from one or more companies identified by the company identifiers; perform data mapping to associate the company identifiers with the purchases represented in the online banking transaction history to identify the companies represented by the company identifiers from which the user made purchases; send the company identifiers to a user device for display on a graphical user interface of the user device.

The system may further comprise the user device.

According to another aspect, there is provided a data mapping method comprising: retrieving from one or more data repositories: company identifiers; and an electronic commerce transaction history of a user, wherein the electronic commerce transaction history comprises one or more purchases made from one or more companies identified by the company identifiers; performing data mapping to associate one or more of the company identifiers with the one or more purchases represented in the electronic commerce transaction history to identify the one or more companies represented by one or more company identifiers from which the user made the one or more purchases; and causing the one or more company identifiers to be displayed on a graphical user interface.

The company identifiers may comprise one or more stock tickers and associated stock exchanges.

The electronic commerce transaction history may comprise an online banking transaction history; retrieving the company identifiers may comprise retrieving the one or more stock tickers from an asset database via an application programming interface accessed through a wide area network; and retrieving the online banking transaction history may comprise accessing a transaction database controlled by a financial institution different from an organization that controls the asset database.

The one or more company identifiers may comprise one or more investment funds comprising the one or more companies.

The electronic commerce transaction history may comprise an online banking transaction history.

The online banking transaction history may comprise a purchase transaction history of the user.

The data mapping may be performed using fuzzy string matching.

Performing the data mapping may comprise: determining string metrics corresponding to respective differences between each of the one or more company identifiers and the one or more purchases; and determining which of the one or more company identifiers are associated with the one or more purchases based on the string metrics.

Each of at least some of the differences may be a Levenshtein distance.

The data mapping may be performed using supervised machine learning, and the method may further comprise: displaying one or more feedback buttons respectively associated with the one or more displayed company identifiers; and in response to receiving feedback, training a supervised machine learning model used to implement the supervised machine learning.

The method may further comprise: prompting the user to allocate a percentage of funds for use in purchasing an interest in the companies identified on the graphical user interface; and in accordance with an investment allocation specified by the user, automatically periodically transferring funds from one financial institution account of the user to another financial institution account of the user assigned for use to purchase the interest in the companies.

The method may further comprise: prompting the user to make one or more additional allocations of funds for use other than to purchase the interest in the companies; and displaying an allocation chart on the graphical user interface graphically depicting the investment allocation relative to the one or more additional allocations, wherein at least one of the one or more additional allocations is for a savings account.

The method may further comprise, in response to the user selecting one of the company identifiers displayed on the graphical user interface, facilitating a purchase of the interest in the company identified by the one of the company identifiers.

The data mapping is performed on one or more servers, and causing the company identifiers to be displayed on the graphical user interface may comprise sending the company identifiers from the one or more servers to a user device for display on the user device.

The data mapping may be performed on a user device, and causing the company identifiers to be displayed on the graphical user interface may comprise displaying the company identifiers on the user device.

Multiple of the company identifiers may be displayed in a ranked order on the graphical user interface.

The company identifiers may be ranked based on how often the companies appear in the electronic commerce transaction history or based on amounts spent at the companies as recorded in the electronic commerce transaction history.

According to another aspect, there is provided a data mapping system comprising: a transaction database; and one or more servers configured to: retrieve company identifiers from an asset database; retrieve from the transaction database an electronic commerce transaction history of a user, wherein the electronic commerce transaction history comprises one or more purchases made from one or more companies identified by the company identifiers; perform data mapping to associate one or more of the company identifiers with the one or more purchases represented in the electronic commerce transaction history to identify the one or more companies represented by one or more company identifiers from which the user made the one or more purchases; and send the one or more company identifiers to a user device for display on a graphical user interface of the user device.

More generally, the system may be configured to perform the foregoing method.

According to another aspect, there is provided a non-transitory computer readable medium having stored thereon computer program code that is executable by a processor and that, when executed by the processor, causes the processor to perform the foregoing method.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a network diagram illustrating one architecture for a data mapping system, according to an example embodiment.

FIG. 2 is a block diagram of a server comprising part of the architecture of FIG. 1.

FIG. 3 is a logical block diagram illustrating the architecture of and connections between a frontend and a backend of a data mapping system, according to an example embodiment.

FIG. 4 is a flow diagram illustrating a data mapping method, according to an example embodiment.

FIGS. 5A and 5B collectively depict a flow diagram illustrating a method for interacting with a graphical user interface customized based on data mapping, according to an example embodiment.

FIGS. 6A-6C depict screenshots of a graphical user interface customized based on data mapping, according to example embodiments.

FIG. 7 is a flow diagram depicting a data collection method performed as part of a data mapping method, according to an example embodiment.

### DETAILED DESCRIPTION

One area where information overload can be an issue is investing. An individual wishing to invest in some kind of security, such as a stock, is presented not only with a very large number of stocks to invest in, but also with all the metrics regarding those stocks to help them decide which are desirable. In at least some embodiments herein, this problem is solved technologically by using data mapping. More particularly, a user's online banking transaction data is mapped to company identifiers, such as publicly traded stock tickers and/or associated stock exchanges in order to determine which publicly traded companies represented by those stock tickers have been the subject of the user's online banking transactions (as used herein, “online banking” refers not only to financial transactions made at a bank, but more generally any financial institution that provides retail financial services, such as credit unions). For example, a user who makes several online purchases at Apple™ Inc. may have those transactions processed and mapped to Apple™ Inc.'s stock ticker (AAPL) and/or other stock information related to Apple™ Inc., such as stock price and the exchange on which AAPL is listed (e.g., the NASDAQ™). A customized graphical user interface may then be prepared and presented to the user via a computing device such as a smartphone to prompt the user of the opportunity to invest in Apple™ Inc. Parsing and processing of online banking transaction data and mapping of that data to securities information accordingly results in a correlation that is used to generate a customized graphical user interface for the user.

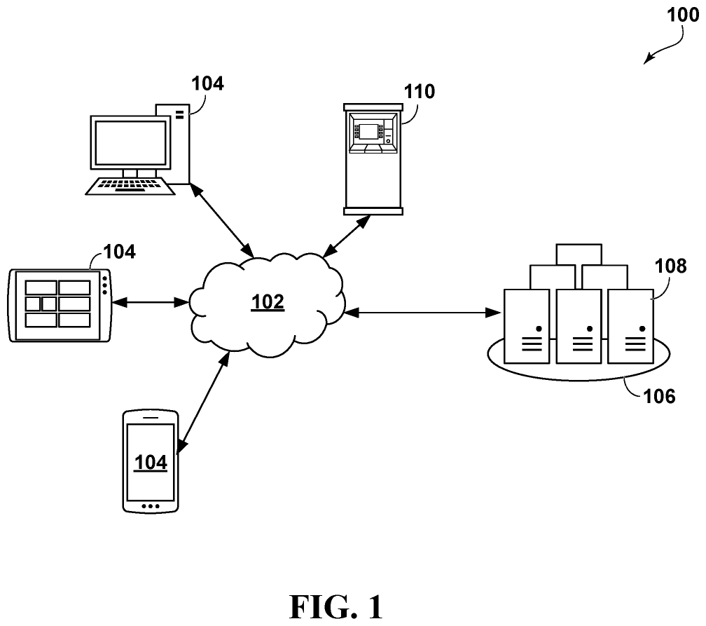

Referring now to FIG. 1, there is shown a computer network 100 that comprises an example embodiment of a data mapping system. More particularly, the computer network 100 comprises a wide area network 102 such as the Internet to which various user devices 104, an ATM 110, and data center 106 are communicatively coupled. The data center 106 comprises a number of servers 108 networked together to collectively perform various computing functions. For example, in the context of a financial institution such as a bank, the data center 106 may host online banking services that permit users to log in to those servers using user accounts that give them access to various computer-implemented banking services, such as online fund transfers. Furthermore, individuals may appear in person at the ATM 110 to withdraw money from bank accounts controlled by the data center 106.

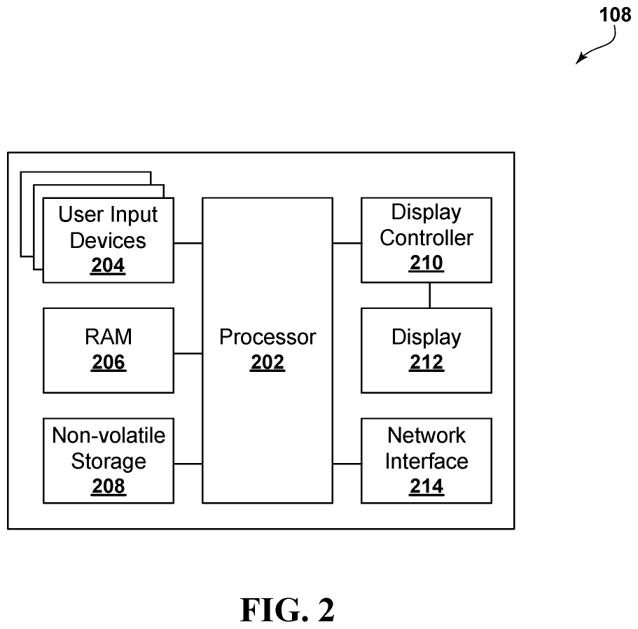

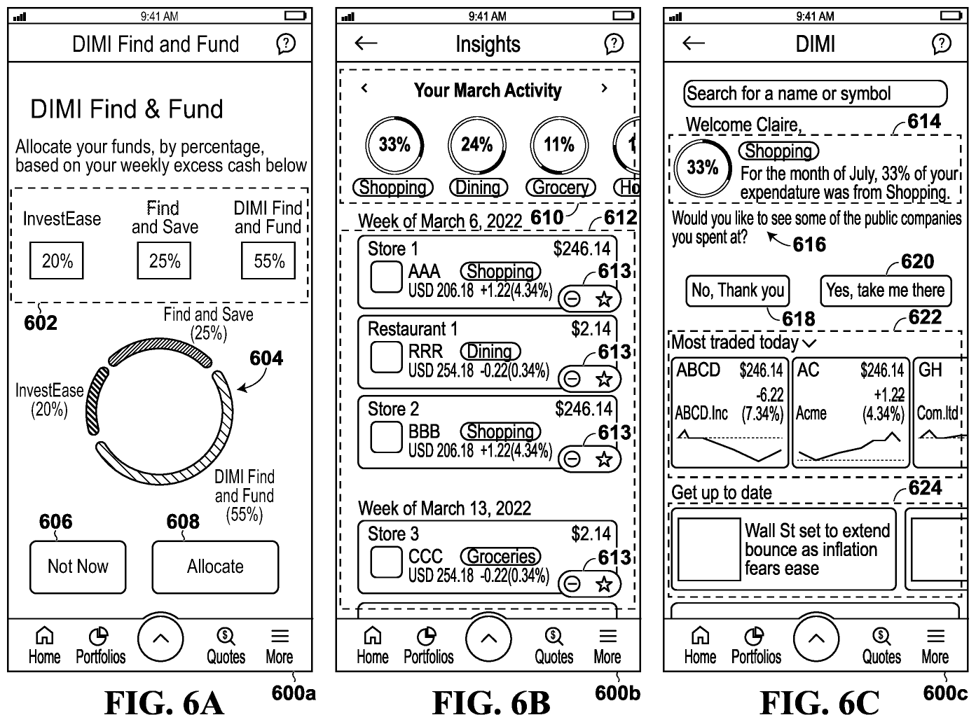

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a data mapping method such as is described in more detail in respect of FIG. 6 below. Additionally or alternatively, the servers 108 may collectively perform that method using distributed computing. While the system depicted in FIG. 2 is described specifically in respect of one of the servers 108, analogous versions of the system may also be used for the user devices 104.

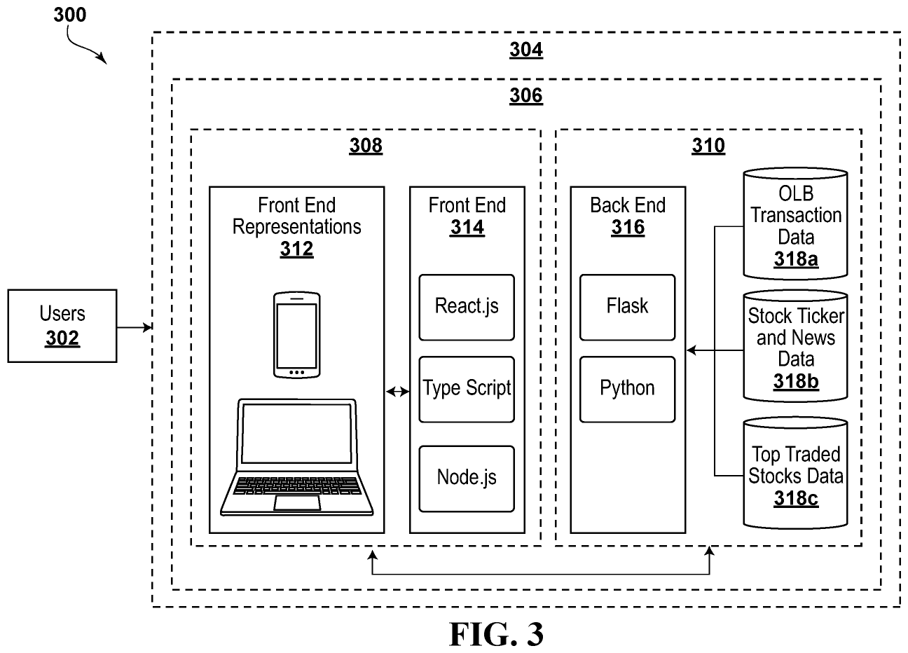

Referring now to FIG. 3, there is shown a logical block diagram illustrating the architecture of and connections between a frontend 308 and a backend 310 of a data mapping system 300, according to an example embodiment. The system 300 of FIG. 3 is generally controlled by a financial institution 304 and is used by users 302, such as the financial institution's 304 clients. The frontend 308 and backend 310 are each implemented as an OpenShift™ cluster 306. The frontend 308 comprises graphical user interfaces (“GUIs”) 312, which may be customized for a desktop or mobile view for example. The GUIs 312 are implemented using a frontend implementation platform 314 comprising React.js and Node.js, TypeScript™, and Tailwind™ CSS. The frontend 308 communicates with the backend 306, which is implemented using a backend implementation platform 316 based on Flask™ and Python™. The backend implementation platform 316 is communicative with a transaction database 318a, which stores histories of the users' 302 electronic commerce transactions, such as online banking transactions; an asset database 318b, which stores information such as publicly traded stock tickers for various stocks and related news articles for those stocks; and a trading database 318c, which stores top traded investments (e.g., stocks and/or ETFs) over one or more predefined time periods, such as the last day, month, and year. Any of the databases 318a-c may be accessed via API calls; for example, the asset database 318b may comprise the Alpha Vantage™ API.

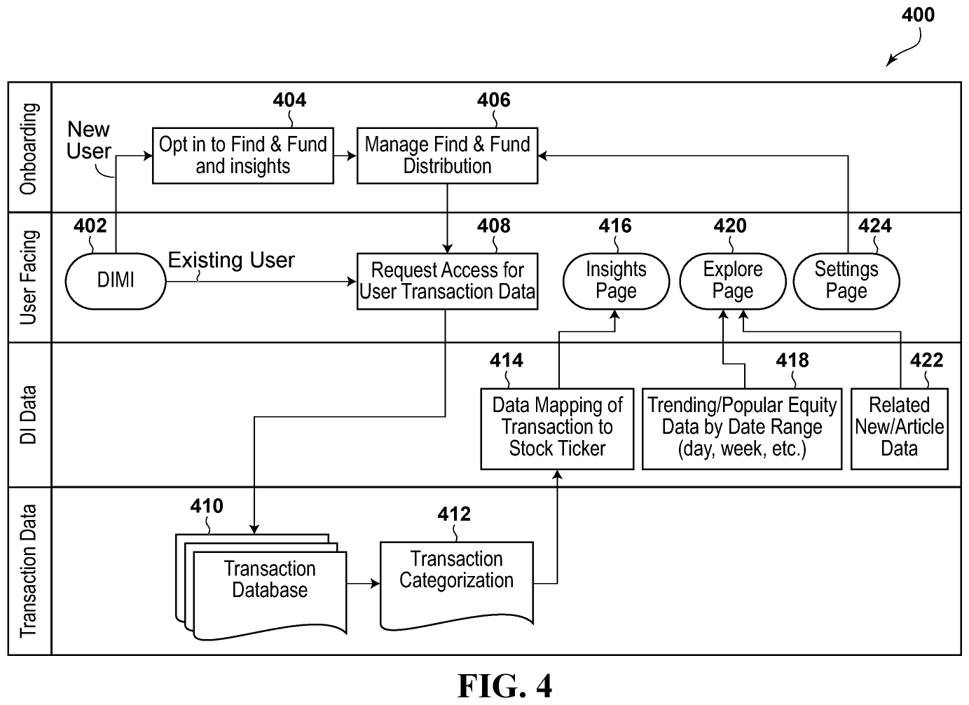

Referring now to FIG. 4, there is shown a flow diagram illustrating a data mapping method 400, according to an example embodiment. The method 400 may be performed using the system 300 of FIG. 3.

The actions in FIG. 4 are categorized into four types: actions related to user 302 “onboarding” (blocks 404 and 406); actions generally involving updating of the GUIs 312 are “user facing” (blocks 402, 408, 416, 420, and 424); acquiring and collating transaction data are in the “transaction data” category (blocks 410 and 412); and processing transaction and other types of data for display on one or more of the GUIs 312 are in the “DI data” category (blocks 414, 418, and 422).

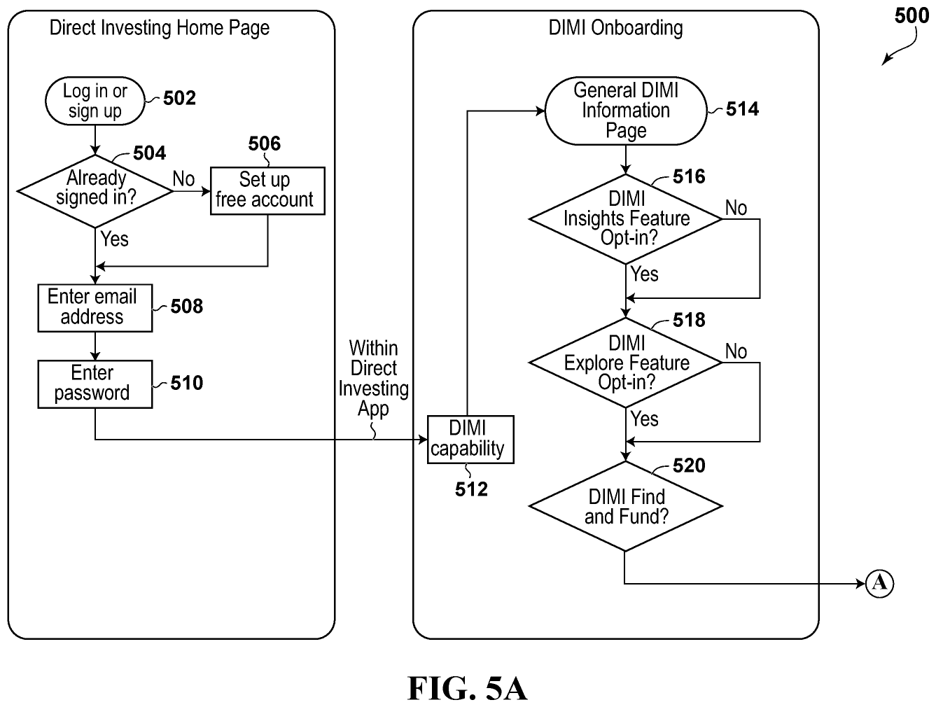

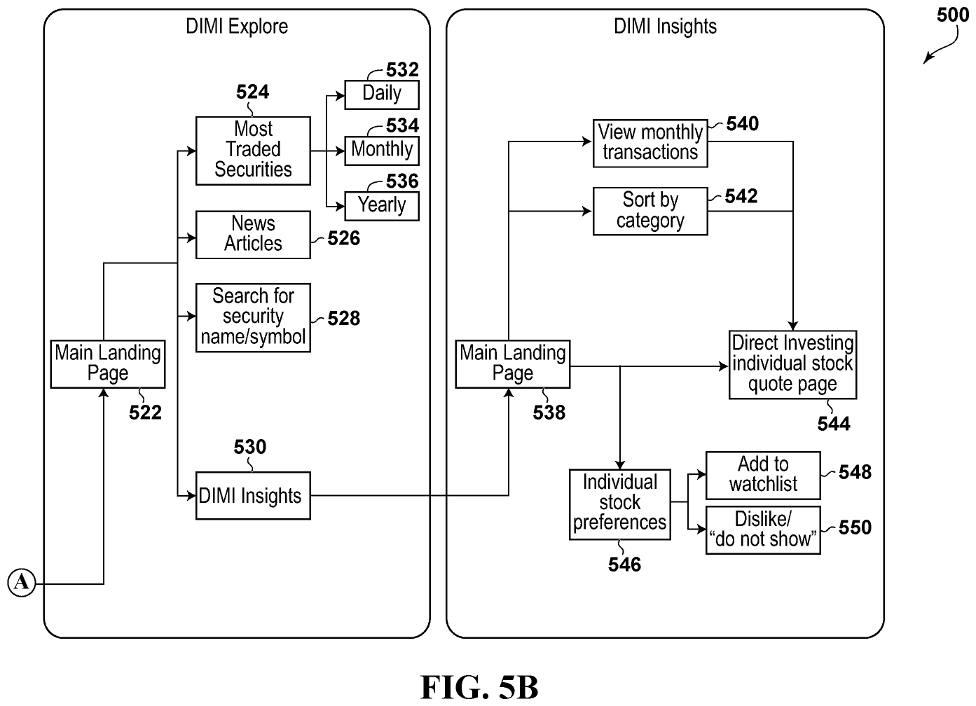

A user 302 begins using the system 300 at block 402, with the reference to “DIMI” being a reference to an implementation of a data mapping system according to an example embodiment. If the user 302 is a new user and does not have an account with the system 300, they proceed to block 404 where they “opt in” to services comprising 1) automatic fund allocation, which automatically identifies from one or more of the user's 302 bank accounts funds to be periodically transferred to one or more of the user's 302 investment or savings accounts; and 2) an “insights” service, which leverages data mapping to prompt the user 302 to invest in companies represented in the user's 302 transaction history. As discussed further below in respect of FIGS. 5, the user 302 at block 406 is then able to actually invest some of the funds allocated to an investment account to purchase stock in those companies. The system 300 populates information displayed on the GUIs 312 from a settings page accessed at block 424; an example settings page 600a is displayed in FIG. 6A.

The settings page 600a depicts a mobile GUI 312, which comprises allocation boxes 602 that show how the user's 302 funds are to be divided between three different accounts: “InvestEase” (a robo-advising investment account), “Find and Save” (a savings account), and “DIMI Find and Fund” (a direct investment account that allows users 302 to invest in any investment of their choosing supported by the system 300, including investments suggested by virtue of being identified during the data mapping mentioned above and described further below in respect of block 414). The system 300 may, for example, transfer a certain amount of money from the user's 302 savings account (e.g., $200) periodically (e.g., monthly) into one or more of the user's 302 other accounts in accordance with certain proportions, such as the three accounts and proportions shown in FIG. 6A. An allocation chart 604 provides a graphical depiction of how transferred money is divided between the three accounts. The user 302 may change allocation percentages by adjusting the amounts in the allocation boxes 602 and then confirming any change by selecting the allocation button 608, or alternatively cancelling any change by selecting the no button 606.

Following block 406, the user 302 then proceeds to block 408. If the user 302 was an existing user and had already completed the onboarding process at time of login, they proceed to block 408 directly and can bypass blocks 404 and 406.

At block 408, the system 300 requests, and the user 302 grants access to, the user's 302 transaction data as stored in the transaction database 318a. The backend 310 subsequently retrieves the user's 302 online banking transaction history (e.g., a list of credit card purchases and/or debit purchases) from the transaction database 318a and categorizes them at block 412 into different spending categories, such as shopping, dining, groceries, and entertainment, for example. Following categorization the backend 310 performs data mapping of the transactions in the user's 302 online banking transaction history to the list of stock tickers at block 414.

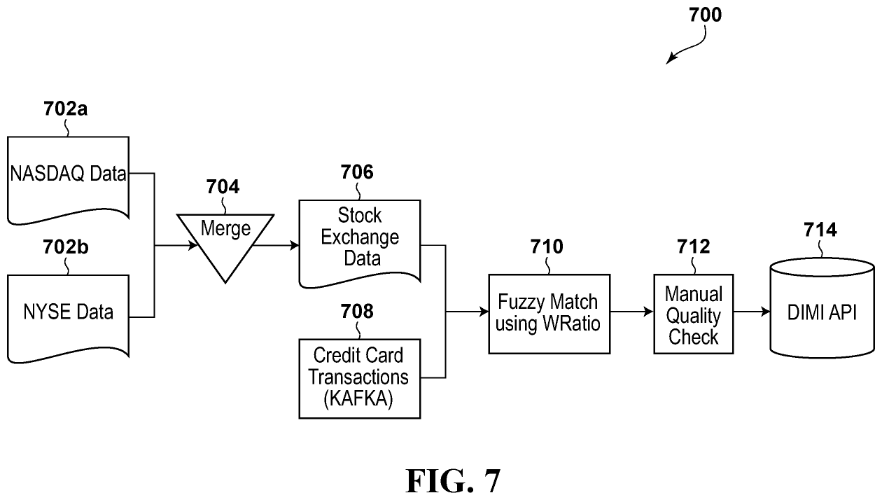

The data mapping may be performed as shown in FIG. 7, which is a flow diagram depicting an example data collection method 700 performed as part of a data mapping method. In FIG. 7, the system stock tickers are pulled from two different sources, which collectively act as the asset database 318b: a NASDAQ™ sticker data repository 702a, such as the NASDAQ™ stock screener; and an NYSE™ sticker data repository 702b, such as the NYSE™ stock screener. The repositories 702a,b may be accessed via respective public APIs accessible through a wide area network such as the Internet, for example. The data from the two repositories 702a,b is merged (e.g., through concatenation) at block 704, resulting in stock exchange data 706. The user's 302 online banking transactions 708 are obtained from the transaction database 318a, which in FIG. 7 is a Kafka™ topic controlled by a financial institution. In FIG. 7, the online banking transactions 708 are in the form of a listing of credit card transactions, with each transaction including a merchant name. The system 300 may perform data mapping in the form of string matching, in which the merchant names for the online banking transactions 708 are matched to the stock exchange data 706 using, for example, the Wratio function from the FuzzyWuzzy™ Python™ library. More generally, the system 300 may perform data mapping by determining a string metric, such as the Levenshtein distance, between a string of text representing each of the online banking transactions 708 and each of the stock tickers represented in the stock exchange data 706 and picking the stock ticker that corresponds to the merchant represented in the online banking transactions 708 based on the result of the string metric (e.g., the highest ranked match may be picked as the stock ticker). A quality check is subsequently performed at block 712, which while manual in FIG. 7 may alternatively be done automatically. The result of the data mapping (i.e., a list of stock tickers and associated stock exchanges) is made available to the rest of the system 300 via an API 714.

The results of the data mapping are displayed as an “Insights page” at block 416. An example insights page 600b, which comprises part of the mobile GUI 312, is shown at FIG. 6B. The insights page 600b comprises an activity summary 610, which shows the user's 302 spending activity for a given time period (in FIG. 6B, the month of March) expressed as different categories of spending. The insights page 600b also displays various investment opportunities 612, which in FIG. 6B take the form of stock tickers that result from the data mapping between the user's 302 online banking transaction history with the stock tickers at block 414. The various investment opportunities 612 may be listed in a ranked order. For example, the investment opportunities 612 may be ranked by how often the companies corresponding to the investment opportunities 612 appear in the online banking transaction history over a certain period (e.g., the last full month), or be based on the amount spent at those companies over that period. The user 302 may select one of the displayed stock tickers and be routed to a page where they can purchase stock(s) represented by the stock tickers on the stock exchange(s) associated with the stock tickers. Each of the stock tickers is also associated with feedback buttons 613, which allow the user 302 to indicate whether the stock ticker represents an investment they are potentially interested in or not. In embodiments in which supervised machine learning is used for data mapping, the system 300 may use this feedback as part of the training process to improve the corresponding supervised machine learning model with a view to improving subsequent investment recommendations.

At block 418 of FIG. 4, the system 300 retrieves trending or popular equity data by a date range (e.g., a particular day, week, etc.). This data may be obtained via the trading database 318c and may represent anonymized data for all of the financial institution's 304 users. The system 300 also retrieves (for example, from a suitable third party API) related news/article data for the stock tickers that were the result of the data matching at block 414. The equity data and the news/article data is shown to the user via the GUIs 312 as an explore page 600c (block 420), as depicted in FIG. 6C.

The explore page 600c shows the user 302 a summary 614 representing what percentage of the user's 302 spending corresponding to which spending category. Below the summary 614 the explore page 600c also presents a prompt 616 to the user, asking them if they wish to see some of the public companies that the user 302 may wish to invest in. If the user 302 wishes to see this list, they push the yes button 620; otherwise they push the no button 618. If the user 302 pushes the yes button 620, the system 300 may in response perform data mapping and show the user 302 the resulting matched stock tickers for only the spending category(ies) displayed in the summary 614. The explore page 600c also displays the trending or popular equity data at the most traded equities 622, and displays suggested news 624 related to equities generally or the user's 302 data matched equities in particular.

Some of the information (e.g., the results of the data mapping in the form of stock tickers) displayed on the GUIs 312 (e.g., the settings page 600a, insights page 600b, and explore page 600c) in the depicted examples is generated on the backend 310 and then caused to be displayed on the user devices 104 by virtue of being sent from the backend 310 to the frontend 308. In at least some alternative embodiments, the user devices 104 themselves may generate the information that they display themselves. For example, in some other embodiments the user devices 104 may perform their own data mapping and may cause the resulting stock tickers to be displayed on their own displays 212 without having to send the stock tickers between the backend 310 and frontend 308.

Referring now to FIGS. 5A and 5B, there is shown a flow diagram illustrating a method 500 for interacting with a graphical user interface customized based on data mapping, according to an example embodiment. More particularly, the user 302 starts by logging into the system 300 or signing up using the system 300 at block 502. If the user 302 is already signed up, they proceed directly to blocks 508 and 510 where they respectively enter login credentials in the form of an email address and password. If the user 302 has not already signed up, they set up an account at block 506 before entering their credentials at blocks 508 and 510.

The user 302 accesses the system's 300 functionality at block 512, is displayed general system information at block 514, and “opts in” to services comprising 1) automatic fund allocation, which automatically identifies from one or more of the user's 302 bank accounts funds to be periodically transferred to one or more of the user's 302 investment or savings accounts (block 520); 2) an “insights” service, which leverages data mapping to prompt the user 302 to invest in companies represented in the user's 302 transaction history (block 516); and 3) an “explore” service (block 518), as described above in respect of FIG. 4. Generally speaking, these operations correspond to blocks 402, 404, 406, and 408 of FIG. 4.

The user 302 is then directed to a main landing page at block 522 for the “explore” service, such as the explore page 600c. As described above, the explore page 600c may show the user's 302 or the financial institution's 304 users' most traded securities (block 524), relevant news articles (block 526), and may even permit the user 302 to search for security names/symbols (block 528). In respect of the most traded securities, daily (block 532), monthly (block 534) or yearly (block 536) windows may be chosen for which the most traded securities are shown.

The user may proceed to the “insights” service at block 530 following which they are shown to a main landing page, such as the insights page 600b. The user 302 may view their monthly transactions (block 540) (e.g., a listing of credit card or online banking transactions) and/or sort their spending by category (block 542). The user 302 may also proceed to an individual stock quote page (block 544) where they are shown the current price for a particular stock and are given an option to purchase it. The user 302 may also be shown their individual stock preferences (block 546), which is a result of the data mapping referenced above, and may be given the option to add any one or more of those particular stock preferences to a watchlist (block 548) or to indicate they are uninterested in the shown stock preference (block 548).

While the foregoing examples focus on matching online banking transaction data to stock tickers associated with specific companies, in at least some other embodiments different types of transaction data may be used. For example, as mentioned above, the online banking transaction data is a subset of electronic commerce transaction data, and in at least some other embodiments (not depicted) electronic commerce transaction data may be used as a source or company names. For example, the method 400 may be implemented by an online retailer, and a user's past order history may be used as the basis for the company names used in the data mapping. In at least some other embodiments, the online banking transaction data may be matched to other kinds of data and/or other types of data may be displayed to the user 302 via the GUIs 312. For example, instead of a ticker for a particular company, the system 300 may identify investment funds (e.g., mutual funds) that include the matched company and display those funds via the GUIs 312.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Phrases such as “at least one of A, B, and C”, “at least one of A, B, or C”, “one or more of A, B, and C”, and “A, B, and/or C” are intended to include both a single item from the enumerated list of items (i.e., only A, only B, or only C) and multiple items from the list (i.e., A and B, B and C, A and C, and A, B, and C). Accordingly, the phrases “at least one of”, “one or more of”, and similar phrases when used in conjunction with a list are not meant to require that each item of the list be present, although each item of the list may be present.

It is contemplated that any part of any aspect or embodiment discussed in this specification can be implemented or combined with any part of any other aspect or embodiment discussed in this specification, so long as such those parts are not mutually exclusive with each other.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A data mapping method comprising:
(a) retrieving from one or more data repositories:
(i) company identifiers; and
(ii) an electronic commerce transaction history of a user, wherein the electronic commerce transaction history comprises one or more purchases made from one or more companies identified by the company identifiers;
(b) performing data mapping to associate one or more of the company identifiers with the one or more purchases represented in the electronic commerce transaction history to identify the one or more companies represented by one or more company identifiers from which the user made the one or more purchases; and
(c) causing the one or more company identifiers to be displayed on a graphical user interface.

2. The method of claim 1, wherein the company identifiers comprise one or more stock tickers and associated stock exchanges.

3. The method of claim 2, wherein the electronic commerce transaction history comprises an online banking transaction history, wherein retrieving the company identifiers comprises retrieving the one or more stock tickers from an asset database via an application programming interface accessed through a wide area network, and wherein retrieving the online banking transaction history comprises accessing a transaction database controlled by a financial institution different from an organization that controls the asset database.

4. The method of claim 1, wherein the one or more company identifiers comprise one or more investment funds comprising the one or more companies.

5. The method of claim 1, wherein the electronic commerce transaction history comprises an online banking transaction history.

6. The method of claim 5, wherein the online banking transaction history comprises a purchase transaction history of the user.

7. The method of claim 1, wherein the data mapping is performed using fuzzy string matching.

8. The method of claim 1, wherein performing the data mapping comprises:
(a) determining string metrics corresponding to respective differences between each of the one or more company identifiers and the one or more purchases; and
(b) determining which of the one or more company identifiers are associated with the one or more purchases based on the string metrics.

9. The method of claim 6, wherein each of at least some of the differences is a Levenshtein distance.

10. The method of claim 1, wherein the data mapping is performed using supervised machine learning, and wherein the method further comprises:
(a) displaying one or more feedback buttons respectively associated with the one or more displayed company identifiers; and
(b) in response to receiving feedback, training a supervised machine learning model used to implement the supervised machine learning.

11. The method of claim 1, further comprising:
(a) prompting the user to allocate a percentage of funds for use in purchasing an interest in the companies identified on the graphical user interface; and
(b) in accordance with an investment allocation specified by the user, automatically periodically transferring funds from one financial institution account of the user to another financial institution account of the user assigned for use to purchase the interest in the companies.

12. The method of claim 10, further comprising:
(a) prompting the user to make one or more additional allocations of funds for use other than to purchase the interest in the companies; and
(b) displaying an allocation chart on the graphical user interface graphically depicting the investment allocation relative to the one or more additional allocations, wherein at least one of the one or more additional allocations is for a savings account.

13. The method of claim 1, further comprising, in response to the user selecting one of the company identifiers displayed on the graphical user interface, facilitating a purchase of the interest in the company identified by the one of the company identifiers.

14. The method of claim 1, wherein the data mapping is performed on one or more servers and causing the company identifiers to be displayed on the graphical user interface comprises sending the company identifiers from the one or more servers to a user device for display on the user device.

15. The method of claim 1, wherein the data mapping is performed on a user device and causing the company identifiers to be displayed on the graphical user interface comprises displaying the company identifiers on the user device.

16. The method of claim 1, wherein multiple of the company identifiers are displayed in a ranked order on the graphical user interface.

17. The method of claim 16, wherein the company identifiers are ranked based on how often the companies appear in the electronic commerce transaction history.

18. The method of claim 16, wherein the company identifiers are ranked based on amounts spent at the companies as recorded in the electronic commerce transaction history.

19. A data mapping system comprising:
(a) a transaction database; and
(b) one or more servers configured to:
(i) retrieve company identifiers from an asset database;
(ii) retrieve from the transaction database an electronic commerce transaction history of a user, wherein the electronic commerce transaction history comprises one or more purchases made from one or more companies identified by the company identifiers;
(iii) perform data mapping to associate one or more of the company identifiers with the one or more purchases represented in the electronic commerce transaction history to identify the one or more companies represented by one or more company identifiers from which the user made the one or more purchases; and
(iv) send the one or more company identifiers to a user device for display on a graphical user interface of the user device.

20. A non-transitory computer readable medium having stored thereon computer program code that is executable by a processor and that, when executed by the processor, causes the processor to perform a data mapping method comprising:
(a) retrieving from one or more data repositories:
(i) company identifiers; and
(ii) an electronic commerce transaction history of a user, wherein the electronic commerce transaction history comprises one or more purchases made from one or more companies identified by the company identifiers;
(b) performing data mapping to associate one or more of the company identifiers with the one or more purchases represented in the electronic commerce transaction history to identify the one or more companies represented by one or more company identifiers from which the user made the one or more purchases; and
(c) causing the one or more company identifiers to be displayed on a graphical user interface.
